(19) United States
(12) Patent Application Publication
(10) Pub. No.: US 2026/0364687 A1
(43) Pub. Date: Nov. 19, 2026

(54) DEVICE FOR SUPPORTING BITS FOR A TOOL

(71) Applicant: Manuel Dimas VARGAS MUNOZ, Cassarate (CH)

(72) Inventor: Manuel Dimas VARGAS MUNOZ, Cassarate (CH)

(21) Appl. No.: 19/132,224

(22) PCT Filed: Nov. 23, 2023
(86) PCT No.: PCT/EP2023/082889

§ 371 Date: May 22, 2025

(30) Foreign Application Priority Data
Nov. 24, 2022 (EP) 22209472.4

(51) Int. Cl. B23B 31/107; B25B 21/00; B25F 5/02

(52) U.S. Cl. CPC B23B 31/1071; B25B 21/007; B25F 5/029

(57) ABSTRACT

A loader/selector device for loading/selecting bits for a working tool, for example a drill, is described, the device comprising: a support structure comprising a mount of the support structure at least one proximal seat for at least one bit for supporting the at least one bit in a position retracted inside the support structure; a distal seat for another bit in a distal position for supporting the other bit with a working surface projecting from the support structure selection means designed to displace the at least one bit from the proximal seat to the distal seat and the other bit from the distal seat to the proximal seat.

### FILED OF APPLICATION

The present invention relates to a device for supporting a bit for a machine tool, for example a device for supporting a cutting or screwing bit for an electric drill.

The present invention also relates to a method for using a device for supporting a bit for a machine tool, of the aforementioned type.

### PRIOR ART

Devices for supporting a bit for machine tools such as electric drills are known. The most well-known and widely used support device is the chuck. The chuck is mounted on the drill so as to grip and rotationally drive a bit, or a tool, such as a cutting bit or a screwing bit. The electric drill is just one example of a machine tool with chuck; other examples are lathes, milling machines, grinders, sharpening machines, axial polishing machines, etc.

The bits are often sold in a container together with the machine tool, thus providing the operator with a wide selection of tools of varying sizes and functions, to be mounted on the chuck depending on the work to be carried out.

Self-centring chucks with three, four or six gripping jaws are known. On portable drills, for example, the chucks may grip helical bits with a diameter ranging from 1 to 13 millimetres or screwing bits of varying diameters. The bits may have a mounting portion or shank with a hexagonal cross-section which facilitates gripping in the chuck.

In particular battery-operated electric drills (or other machine tools) which are packaged together with multiple bits are very popular owing to their transportability, allowing operators to carry around with them everything which is needed to perform a particular job.

However, the known devices have a drawback which arises especially when the operator is working in cramped or uncomfortable conditions, for example standing on the steps of a ladder, where there is not enough space to place the container with the bits. In such a situation the operator mounts a first bit on the chuck and keeps another bit within easy reach, for example in a pocket, while leaving the container on the ground. When the operation with the first tool has been completed, the first tool is removed from the chuck and the other bit is mounted in place of it. This operation, when carried out at the top of a ladder, may be dangerous and is any case awkward and somewhat difficult to perform. It often happens that a third tool, which is not within easy reach, is required. In this case, the operator must climb down the ladder, select the third tool from the container and climb back up the ladder.

The technical problem underlying the present invention is to devise a device for supporting a bit for a machine tool, in particular a device for supporting a cutting bit or screwing bit, which simplifies the operator's activity, especially in conditions where the working space is difficult to access or cramped, thereby overcoming the limitations and drawbacks which currently affect the support devices of the prior art.

US2003/079580, US2009/235789, U.S. Pat. No. 5,024,566 and JPH0674279 as examples of devices for supporting bits for a tool.

### SUMMARY OF THE INVENTION

A support device for a bit of a machine tool according to the present invention is claimed in claim 1.

The machine tool is for instance of the type comprising a chuck. The support device includes a mount intended to be gripped by the chuck in a proximal position close to the chuck.

However, the machine tool may be of the type not including a chuck. In this case, the support device includes a mount intended to be mounted directly to the machine tool, with no chuck between the machine tool and the support device.

Therefore, where the disclosure is given with reference to a machine tool including a chuck, this feature (the chuck) has not to be considered in a limiting way or essential. The skilled person may easily understand that the support device can be applied to both a machine tool with or without a chuck.

Further characteristic features and advantages of the support device according to the present invention and of a method of use thereof are described below with reference to the attached figures, provided only by way of a non-limiting example of the scope of protection of the present invention.

### BRIEF DESCRIPTION OF THE ATTACHED FIGURES

FIG. 1 shows a perspective view of a support device comprising a loader/selector for a machine tool bit, with the device mounted on the chuck of the machine tool.

FIG. 2 is a perspective view of the support device shown in FIG. 1, with part detached from the chuck.

FIG. 3 is another perspective view of the support device according to FIG. 1, with part detached from the chuck and rotated about the axis X1 compared to the view shown in FIG. 2.

FIG. 4 is another perspective view of the support device according to FIG. 1, with part detached from the chuck and with a cutting bit inserted.

FIG. 5 is another perspective view of the support device according to FIG. 1, with part detached from the chuck and with a screwing bit inserted.

FIG. 6 is a perspective view of a circular crown-piece of the loader/selector of the support device according to FIG. 1.

FIG. 7 is a perspective view of a cover of the circular crown-piece of the loader/selector of FIG. 6, with parts partially detached.

FIG. 8 is an exploded perspective view of the cover and the circular crown-piece of FIG. 7 and of a body of the loader/selector according to FIG. 1.

FIG. 9 is another perspective view of the support device according to in FIG. 1.

FIG. 10 is a cross section view of the support device according to another embodiment of the present invention.

FIG. 11 is a schema of a detail of the support device according to FIG. 10.

FIG. 12 is a front view of the support device according to FIG. 10.

FIG. 13 is a perspective view of the support device according to FIG. 10.

### DETAILED DESCRIPTION OF THE INVENTION

With reference to the attached figures, a support device for a bit of a machine tool is described. The machine tool is of the type comprising a chuck 50. The support device, however, may be applicable also to machine tool of the type non including a chuck. The machine tool is for example an electric drill.

The electric drill is only one non-limiting example of a machine tool on which the support device of the present invention can be fitted. Other examples are lathes, milling machines, grinders, sharpening machines, axial polishing machines, etc.

The bit is for example a cutting bit or a screwing bit. Multiple bits, of varying sizes and with different features, which are chosen depending on the work to be done, are often sold together with the machine tool inside a container. The bits may have a mounting portion or shank with a hexagonal cross-section which facilitates gripping. These bits are also called “insert bits”.

The support device according to the present invention comprises a loader/selector 100 intended to be arranged between the chuck 50 of the machine tool and the bit (tool) 88 (if the chunk is present) or directly on the machine tool.

The bit, for example the insert bit 88, is supported at one end of the loader/selector 100 and not directly by the chuck 50. The chuck 50 instead supports the loader/selector 100. The chuck 50 is clamped onto a mount 5 of the loader/selector 100. The mount 5 is located at one end of the loader/selector 100. The mount 5 is located close to the chuck and extends along an axis X1.

In case the chunk is not provided on the machine tool, the mount 5 is directly mounted onto the machine tool. Also in this case, the mount 5 extends along the axis X1, also indicated as central axis X1.

The central axis X1 corresponds to an axis X2 of the bit 88 mounted on the loader/selector 100, at a distal position spaced from the chuck 50 (when provided), at the front end of the support device. The chuck 50 rotationally drives the loader/selector 100 and therefore the bit 88. When joined together and duly tightened, the chuck 50, support device (loader/selector 100) and bit 88 are locked together and intended to rotate at the same angular speed. The same apply when the mount 5 is tightened (instead of to the chuck) to a shaft of the machine tool, for instance the shaft which is actuated by the machine tool electric motor.

The loader/selector 100 is intended to support a bit 88 at its front end, in an operating position, and at least one bit 88 in a non-operating position, retracted from the front end. In the retracted position, the bit is hidden. A support structure 18 of the loader/selector 100 encloses the bit 88 in the retracted position so that it does not pose any danger for the operator.

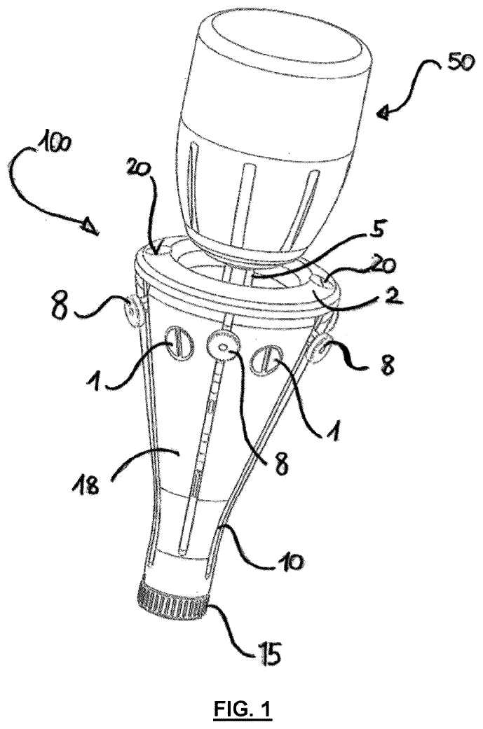

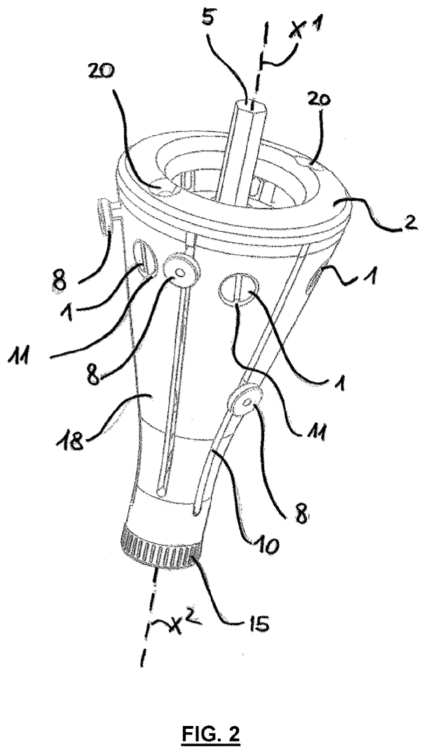

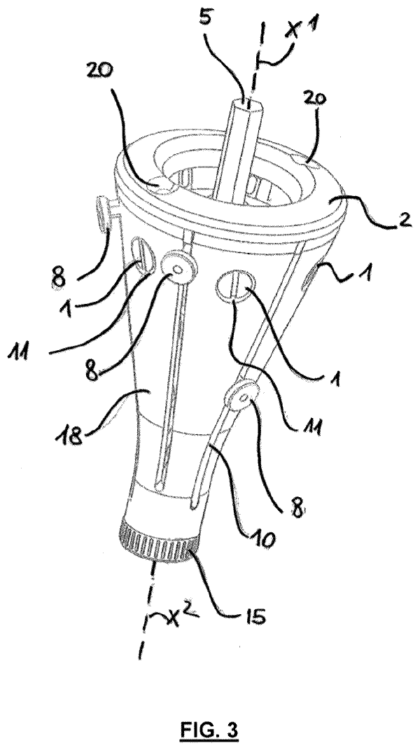

Firstly, an embodiment in which there only two bits 88 is described one bit in an operating position in the support device and one bit in a position retracted within the support device. This embodiment is not shown in FIGS. 1-9. However, in the following description, reference is in any case made to the reference numbers shown in FIGS. 1-9 as a reading aid, since the person skilled on the art will understand, even if the embodiment in FIGS. 1-9 relates to a loader/selector provided with multiple seats for a plurality of bits (i.e. more than two bits and seats), that other variants may be envisaged on the basis of the present disclosure and FIGS. 1-9, for example variants with only two seats for two respective bits. Furthermore, it is quite possible for the embodiment with multiple seats to be used to support only one bit in the retracted position and one bit in the operating position.

The support structure 18 comprises the mount 5 intended to be gripped, for instance, by the chuck 50 in the proximal position close to the chuck 50. The mount 5 may be integral with the support structure.

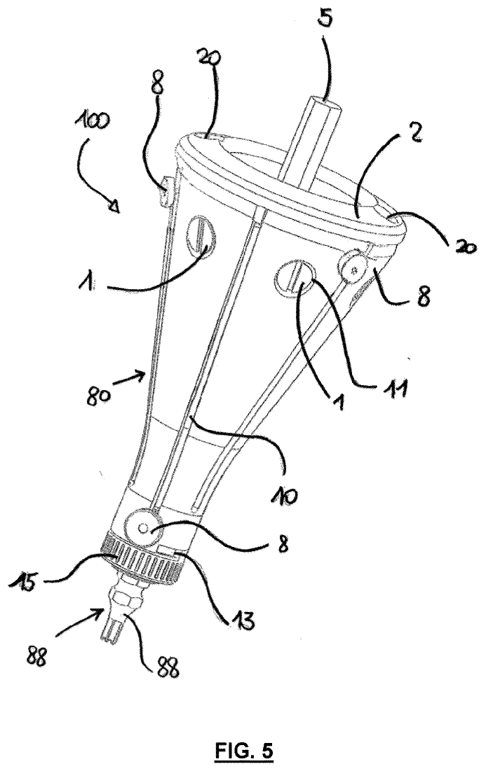

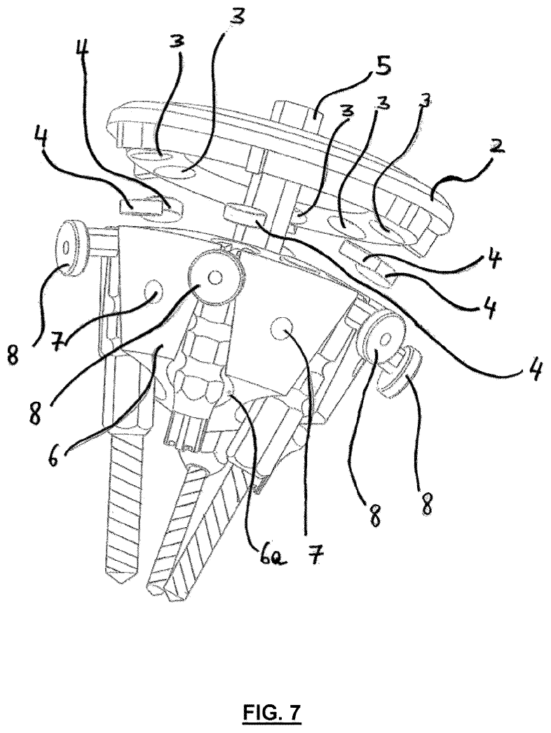

The support structure 18 comprises a proximal seat 6a (FIG. 7) for the bit 88, for supporting said bit in the position retracted inside the support structure 18. The proximal seat 6a and the retracted bit 8 are protected by a body 80 (FIG. 5) of the support structure 18 so that during the rotational movement they do not pose any danger for the operator (the operator may come into contact with the surface of the body 80, but not with the bit 88 in the retracted position). The body 80 also form channels for sliding the bits, as will be described.

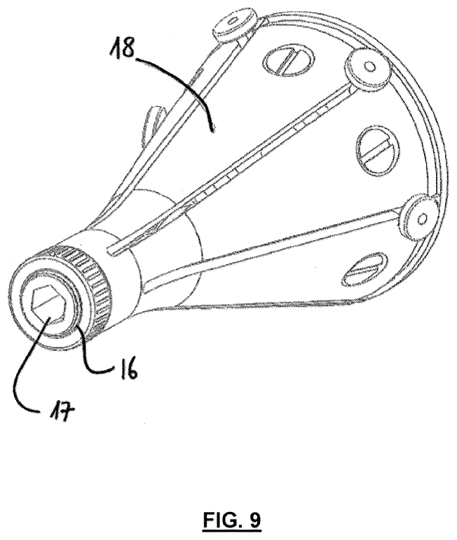

The support structure 18 also comprises a distal seat 17 (FIG. 9) for another bit 88. The distal seat 17 is at a distal position (for instance more distanced from the chuck 50 than the proximal seat 6a) and is intended to support the other bit 88 in the operating position. Said other bit 88 therefore has a working surface (cutting tip, screwing tip) projecting from the support structure 18.

The loader/selector 100, in this example (only two bits), is configured to load a bit in the retracted position and to position selectively another bit in the operating position.

Selection means are provided for displacing the bit 88, for example a screwing bit, from the proximal seat 6a to the distal seat 17 and for displacing the other bit, for example a cutting bit, from the distal seat 17 to the proximal seat 6a. This displacement is performed by the operator when the operation with the cutting bit has been completed and the screwing bit is required.

The operation may be performed manually, as described in the description below. However, it is quite possible that selection of the bit to be used may be performed electronically; in this case, it is envisaged that the support device comprises a controller and bit displacement means which are electrically powered, for example by means of the same battery which powers the machine tool.

According to one embodiment, the selection means switch over the positions of the bit 88 in the retracted position and of the other bit 88 in the operating position. The switch-over operation is performed by operating a single operating device, for example a slider, which by means of a single displacement, for example from position A to position B, inverts the position of the two bits 88. Conversely, operation of the operating device from position B to position A inverts again the position of the two bits 88. If electronically controlled, switching may be performed by means of a switch. In this case, for instance, a kinematics connecting the two bits is provided. By means of sad kinematics, displacement of one bit in one direction (towards the proximal seat) automatically cause displacement of the other bit in the other direction (towards the distal seat).

In one mode of use, the support device is used without a chuck, for example so as to provide a manual screwdriver (or other manual tool) with interchangeable bits. The support device may have a form obviously different from that shown in FIGS. 1-9 and therefore also the form of a screwdriver which conceals inside the handle a retracted bit with a star head and which exposes a bit with a flat head. The handle may be provided with selection means which switch between the flat-head bit and the star head bit. Similarly, multiple manual tools, in particular the tools which are commonly used by a carpenter, may be designed on the basis of the present disclosure, so as to load one or more bits in the retracted position and to select one bit in the operating position.

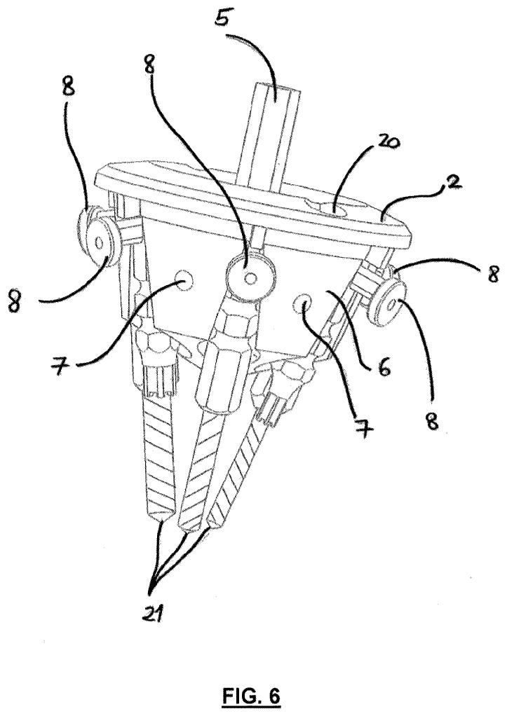

The example of embodiment provided with reference to FIGS. 1-9 relates specifically to a device for supporting multiple bits in the retracted position. More specifically, multiple proximal seats 6a for multiple bits 88 in the retracted position in the support structure 18 are illustrated in the detail of FIG. 6.

The selection means 8 are sliders which are designed to displace selectively the bit 88 from the distal seat 17 (operating position) into the proximal seat 6a (retracted position) and a desired bit chosen from among the multiple bits 88 from the proximal position 6a (retracted position) into the distal position 17. In the example illustrated, these displacements are performed in sequence, namely first the operating position is freed with the displacement of a slider 8 and then the operating position is occupied again with the displacement of another slider 8. As indicated above, the displacements may be controlled electronically, in which case a luminous or LED screen interface, together with respective selection instruments (of the pushbutton or touch type to mention a few examples), for selecting the bit to be moved into the operating position, could be provided.

The bit 88 may be visible through the body 80 of the support structure 18, which may be transparent, thus simplifying the selection of the desired bit 88.

In one embodiment, the multiple proximal seats 6a are arranged in a circular crown-piece 6 of the support structure 18. The crown-piece 6 is intended preferably to remain in the proximal position close to the chuck 50. In fact, since it is a structure designed to support multiple bits, the circular crown-piece 6 has a size bigger than a front end (distal end or distal tip 19a) of the support device which supports a single bit, which must be small so as not to interfere with the bit in the operating position, during displacement, in particular rotation. Therefore, the support structure 18 may have a conical or tapered form, more preferably a funnel like shape (as disclosed in more detail below) with a smaller diameter towards the front end and largest diameter close to the mount 5.

In particular, the support structure 18 comprises the body 80. The body 80 covers the circular crown-piece 6 and extends, tapering, towards the distal seat 17. In one embodiment, the body 80 forms guides 10 for the sliders 9. Each guide 10 extends from the circular crown-piece 6 towards the distal seat 17 so as to guide one of the bits from the proximal seat 6a to the distal seat 17, and vice versa. Each guide 10 is formed for example by a pair of adjacent surfaces of the body 80; the surfaces are spaced by a predefined amount, equivalent to the length of the guide 10, and are joined together at least close to the distal part, where the front end of the support device is situated.

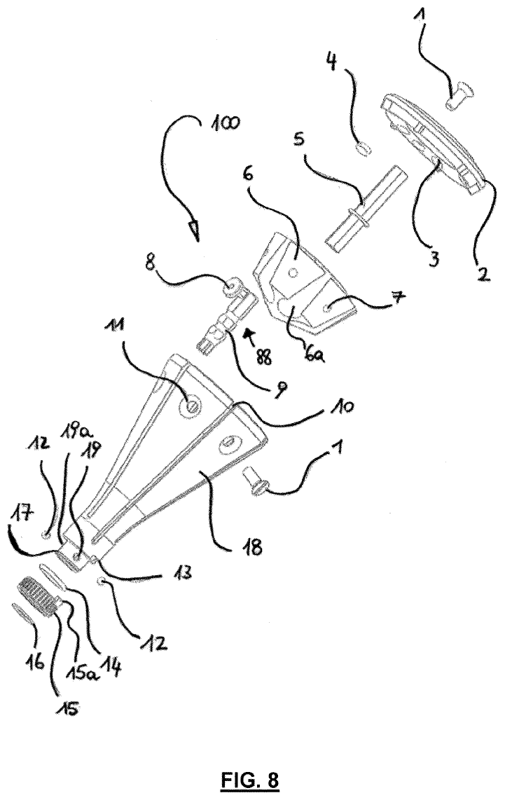

With reference to FIG. 6, it can be noted that multiple bits 88 are inserted in multiple seats 6a of the circular crown-piece 6. Each bit 88 comprises the slider 8 sliding inside a guide 10 of the body 8 of the support structure 18. The slider 8 has a metallic part and the circular crown-piece 6 is associated with a permanent magnet 4 which retains the multiple bits 88 inside the multiple seats 6a. Such a configuration is shown in FIG. 8. The slider 8 has a substantially L-shaped form, namely consisting of a base section and a section perpendicular to the base; the slider 8 is at the end of the base section, the mounting portion, for example the hexagonal cross-section mounting portion of the bit is at the bottom end of the perpendicular section, and the tool, for example a screwing bit, is at the end of the perpendicular section. This shape of the slider (and the bit) is for instance visible in FIG. 8. The hexagonal cross-section mounting portion of the bit is at least partly inserted inside the seat 6a of the circular crown-piece, with the slider 8 projecting therefrom. The seat 6a is at least partly open at a base of the circular crown-piece 6 directed, during use, towards the chuck 50 (or the machine tool, in general). The magnet 4 is operationally associated with the hexagonal cross-section mounting portion of the bit at the opening of the seat 6a and the hexagonal cross-section mounting portion is metallic and therefore attracted by the magnet 4.

Other releasable fixing means, other than a magnet, may be provided, these having the same function of locking the mounting portion with hexagonal cross-section, or hexagonal shank, or other cross-section of the bit 88 inside the seat 6a in the distal position spaced from the chuck 50. Preferably, a width of the multiple seats 6a in the proximal part of the circular crown-piece 6 corresponds to a thickness of the shank. Even more preferably, the shank snap-engages inside the seat 6a.

The Applicant has contemplated the possibility of the support structure being able to house bits of varying sizes. This possibility involves providing different-size guides and a particular form of the circular crown-piece. Again, with reference to FIG. 6 it is possible to note that multiple bits 88 comprise a hexagonal shank. The bits have two different lengths. The cutting ends have one length and the tool mounting ends have a length smaller than the length of the cutting ends. The example is provided only by way of example, and other forms and sizes may be considered.

Each seat for the multiple bits 88 comprises a surface for supporting at least part of the shank. The surface extends from a proximal side to a distal side of the circular crown-piece 6, converging towards the centre of the distal side so that the part of the bits situated opposite to the shank, i.e. the tip of the bit, converges towards an axis of the support structure 18, corresponding to the axis of the mount 5. In other words, the surface of the seat 6a is such that the bit 88 is not positioned parallel to the axis X1 of the support device, but instead so that it converges towards the axis XI. Therefore, a first section of the bit 88 close to the chuck 50 is further away from the axis X1 than any section of the bit 88 which is more distant from the chuck 50 than the first section.

All the bits have preferably the same distance from the axis X1 at the base of the circular crown-piece 6.

Owing to such features it is possible to optimize the space inside the body 80 and house bits 88 of varying length. The bits 88 of varying length are preferably housed alternately inside the multiple seats of the circular crown-piece 6.

The circular crown-piece 6 is fixed onto the body 80 of the support structure 18, preferably screwed by means of screws 1 passing through side surfaces of the body 80 which extend between two guides 10 and engaging inside holes 7 in side surfaces of the circular crown-piece 6 situated between the seats 6a of the circular crown-piece 6.

The support structure 18 also comprises a cover 2 fixed to the base of the body 80. The cover 2 is the seat for the permanent magnet 4, preferably for multiple magnets 4 which are associated with respective bits 88, as shown in FIG. 8. Each magnet 4 has a seat 3 in the cover 2, as shown in FIG. 8. In the embodiment shown in FIG. 8, the mount 5 is a spindle which engages inside the circular crown-piece 6 and the cover 2 and is held in position by a screw 1 which engages with the spindle 5 and bears against the cover 2. The cover 2 is fixed by means of screws 20 on the circular crown-piece 6.

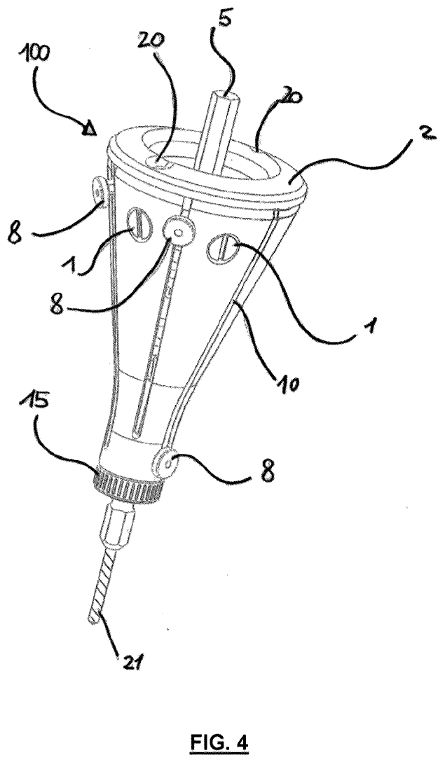

A method for changing the bit supported by a support device according to the present disclosure comprises the steps described below. Firstly, the support device may be in an initial configuration in which a bit, for example a drilling bit with a threaded portion 21, is selectively supported at a distal end of the support, as shown in FIG. 4. The distal end is at an end or tip 19a of the device shown in the exploded view of FIG. 8. The end 19a may be formed as one piece with the body 80 or can be mounted thereon, as a component of the support structure 18. Two or more holes 19 are formed in a cylindrical peripheral portion, i.e. a cylindrical peripheral body of the end 19. Two or more ball bearings 12 are intended to engage partly inside the holes 19, projecting partly into the space inside the end 19a, depending on the position of the flange 15 which is intended to assume two positions. In one position, where a tooth 15a of the flange 15 engages in a seat 13 of the end 19a, the balls partially engage inside the holes 19, projecting partly into the space inside the end 19a and entering into a recess 9 of the bit which is situated at the end 19a. The recess 9 is in the aforementioned position when the slider 8 is at the end of its travel inside the guide 10. O-rings 14, 16 are provided for engagement of the flange 15 with the end 19a. Release of bit 88 is performed by disengagement of the recess 9/balls 12, which is achieved by re-establishing a previous position of the flange 15, with corresponding release of the balls 12 from the holes 19.

Therefore, from the initial configuration where the drilling bit is fixed inside the support device, the operator releases the flange 15, freeing it from the balls 12. At this point, the slider 8 is retracted into the proximal position close to the chuck 50 and together with it the entire bit slides into the retracted position where the magnet 4 retains the bit inside the seat 6a of the circular crown-piece 6.

The positioning of another bit, for example a screwing bit, such as that shown in FIG. 5, is performed as follows: the slider 8 associated with the bit is displaced into the distal position at the end 19a of the support device; the flange 15 is rotated again, fixing the bit 88 in position, with the balls 12 engaged inside the recess 9 of the bit.

All the operations are performed by operating the sliders and not the bits. Multiple bits are pre-loaded. Manual operation may be replaced by electrical means. The operator's work is greatly simplified and speeded up, especially when it is required to work in tight and cramped spaces where there is no room for the operator to bring the machine tool case.

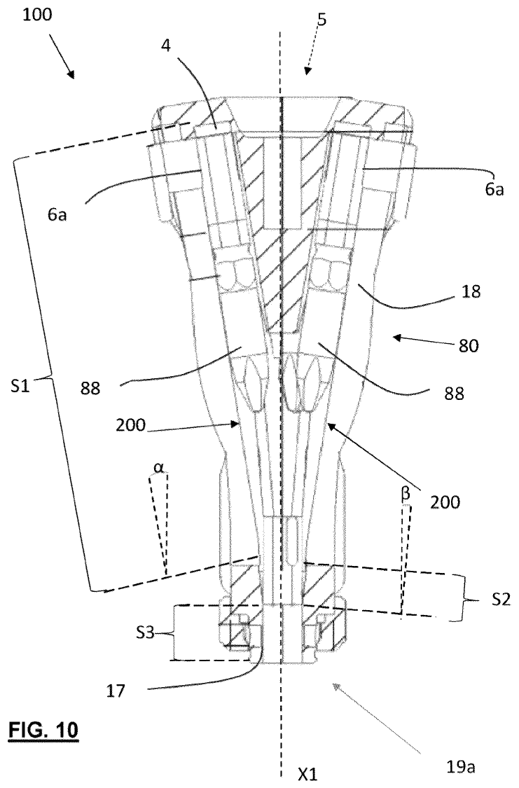

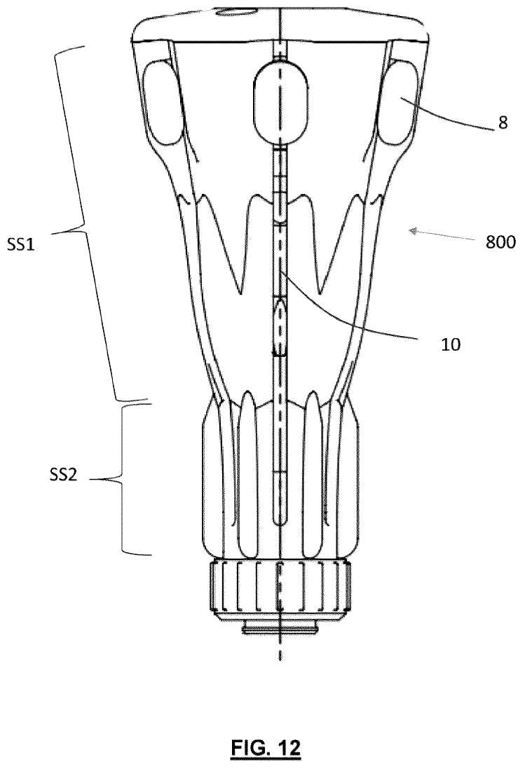

FIG. 10-13 also represents the support device for a bit of a machine tool according to the present invention. The loader/selector 100 is suitable to load/select bits 88 for the machine tool.

The support structure 18 comprises the mount 5; at least one proximal seat 6a for at least one bit 88 for supporting the at least one bit in a position retracted inside the support structure 18; the distal seat 17 for another bit 88 in a distal position for supporting the other bit with a working surface projecting from the support structure 18.

Selection means designed to displace the at least one bit 88 from the proximal seat 6a to the distal seat 17 and the other bit from the distal seat 17 to the proximal seat 6a are also provided by the support structure, as already disclosed above.

In FIG. 10 is represented a channel (200) of the support structure extending from the at least one proximal seat 6a to the distal seat 17.

The channel 200 has, at a first section S1 of the support structure 18, a first inclination α with respect to the central axis X1 of the support device and, at a second section S2 which is closer to the distal seat 17 than the first section S1, a second inclination β less than the first inclination α. Advantageously, said different inclinations allows displacement of the bits in a more compact space within the support structure.

The second section S2 with the second inclination β less than the first inclination α may be not parallel to the central axis X1. In this case, a third section S3, at the end or tip 19a of the support structure 18, has a third inclination γ (0° inclination) and is parallel to the central axis X1. Advantageously, three inclinations allow maneuvering more fluidly the bits in the channels.

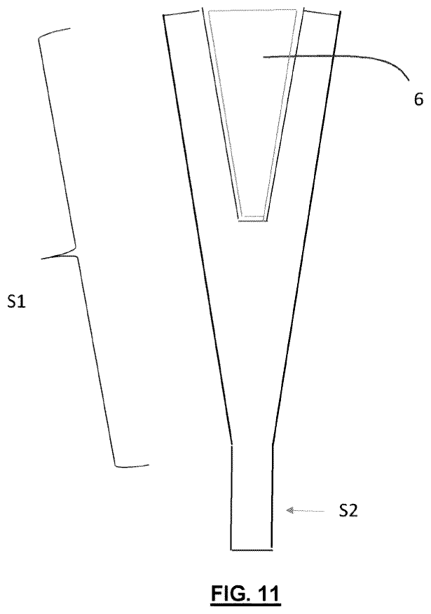

When only a first section S1 of a first inclination α and a second section S2 of a second inclination β are provided, the second section S2 has 0° inclination. FIG. 11 schematically represent this possibility.

Preferably, the support structure has a funnel like shape, wherein the second section S2 (or the third section S3, if present) is the spout of the funnel like shape. In one embodiment.

The at least one bit 88 in a position retracted inside the support structure 18 is not in contact inside the channel 200 with the other bit with the working surface projecting from the support structure 18. In other words, the bit in the operative portion does not contact the bit in the retracted position. Advantageously, vibration of the bit in the operative position are not directly transferred to the bit in the retracted portion (not operative position).

Although the above has been disclosed with reference to a channel 20, the support structure 18 may delimit a plurality of channels 200 (FIG. 10) for a plurality of bits. Each of the plurality of channels 200 runs close to the inner surface of the funnel like shape support structure along the first section S1. Only one bit at a time may enter the spout (at the second S2 or third section S3).

The multiple proximal seats 6a for multiple bits 88 are in positions retracted inside the support structure 18. Such positions are in correspondence of the portion of the funnel like shape having a greater diameter. The multiple proximal seats 6a are arranged in circle.

The support structure 18 includes the circular crown-piece 6 situated in the proximal position. The support structure 18 comprises the body 80, designed to be grabbed for use. The body 80 comprises the guide 10 for each of the at least one bit 88 in the proximal seat 6a and the other bit(s) in the distal seat. Each guide 10 is engaged by the slider 8 of one bit which slides between the proximal seat 6a and the distal seat 17.

The channel 200 extending from the at least one proximal seat 6a to the distal seat 17 is formed within the body 80.

The body is 3D printed.

The body 80 has an external surface 800 extending tapering towards the distal seat 17.

The external surface 800 includes a first surface SS1, having a first inclination α′ with respect to a central axis X1 of the support device and, a second surface SS2 closer to the distal seat 17 than the first surface SS1, having a second inclination β′ less than the first inclination α′.

The length of the second surface SS2 in the direction of the central axis X1 is greater than the length of the second section of the channel 200. Advantageously, this configuration decuples manoeuvrability of the bits in the channels from usability of the machine tool, this last (usability) depending on the shape and length of the second surface SS2, being the second surface SS2 of the machine tool the one which is directly faced to the element (screw or other) to be driven.

The body 80 covers the circular crown-piece 6.

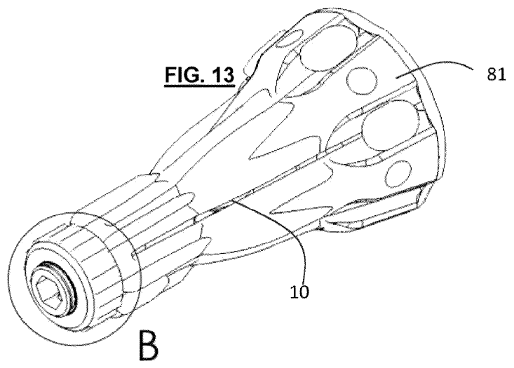

The support structure 18 comprises releasable fixing means for locking a mounting portion of the other bit 88 in the distal position. These means include the flange 15, which is represented in the particular B of FIG. 13.

The distal seat 17 is at the tip 19a of the device.

The distal seat 17 is a hollow cylindrical body including at least one hole in a peripheral portion of the hollow cylindrical body, preferably at least two holes on diametrically opposite sides of the peripheral portion.

Respective at least one or two ball bearings 12 engage the at least one or two holes

The flange 15 is engaged, in one locking position, on the hollow cylindrical body, to keep the at least one or two ball bearings partially projected inside the hollow cylindrical body into the recess 9 of the bit 88. Engagement of the flange 15 in locking in the hollow cylindrical body is for instance by means of the seat 13 of the end 19a, as already disclosed with reference to FIG. 8. The flange 15 and the hollow cylindrical body may be threaded.

The recess 9 is on a peripheral surface of the bit 88 and forms the mounting portion of the bit 88. The bearing(s) 12 lock the bit by shape coupling with the recess 9 thereof.

As said, multiple bits 88 of varying lengths may be housed in the multiple proximal seats 6a.

Preferably, a bit 88 of a first length L is arranged between two bits 88 of another length l. Said another length l is less that the first length L.

The circular crown-piece 6 is fixed onto the body 80 of the support structure 18. Preferably circular crown-piece 6 is screwed by means of screws passing through side surfaces 81 (FIG. 13) of the body 80 which extend between two guides 10, and engaging inside holes in the surfaces of the circular crown-piece 6.

1-20. (canceled)

21. A support device for a plurality of bits of a machine tool, the support device comprising:
a loader/selector for loading/selecting bits for the machine tool;
a support structure including:
a mount;
a plurality of proximal seats, each of the plurality of proximal seats for supporting one bit of the plurality of bits in a position retracted inside the support structure;
a distal seat for supporting one bit of the plurality of bits in a distal position, with a working surface projecting from the support structure;
selection means designed to displace one bit of the plurality of bits from one of the proximal seat to the distal seat and the one bit from the distal seat to the one of the proximal seats;
a channel extending from the proximal seats to the distal seat, wherein the channel has, at a first section, a first inclination with respect to a central axis of the support device and, at a second section, closer to the distal seat than the first section, a second inclination less than the first inclination, wherein the channel includes a third section, at a tip of the support structure, having a third inclination different from the second inclination, the third section having no inclination with respect to the central axis; and
releasable fixing means for locking a mounting portion of said one bit in the distal position, wherein the distal seat is the tip of the support device, the distal seat is a hollow cylindrical body including at least one hole in a peripheral portion of the hollow cylindrical body, wherein respective at least one or two ball bearing engage said at least one or two holes, wherein a flange is engaged in one locking position on the hollow cylindrical body to keep the at least one or two ball bearings partially projected inside the hollow cylindrical body into a recess of said one bit, the recess being on a peripheral surface of said one bit and forming the mounting portion of the bit

22. The support device according to claim 21, wherein each one of said plurality of bits in the proximal seats is not in contact inside the channel with said one bit with the working surface projecting from the support structure.

23. The support device according to claim 21, wherein said selection means selectively displace said one bit from the distal seat to the proximal seat and said one bit of the plurality of bits from the proximal seat to the distal seat.

24. The support device according to claim 21, wherein said proximal seats are arranged in circle.

25. The support device according to claim 21, wherein the support structure includes a circular crown-piece situated in the proximal position.

26. The support device according to claim 21, wherein the support structure includes a body, designed to be grabbed for use, the body includes a guide for each of said plurality of bits in the proximal seats and one bit in the distal seat, each guide being engaged by a slider of one bit of said plurality of bits sliding between the proximal seat and the distal seat.

27. The support device according to claim 26, wherein said channel extending from the proximal seats to the distal seat is formed within the body, the body being 3D printed.

28. The support device according to claim 21, wherein each bit of said plurality of bits includes a metallic part and said support structure includes permanent magnets suitable to retain the plurality of bits in the proximal seats.

29. The support device according to claim 27, wherein the body has an external surface extending tapering towards the distal seat, the external surface including a first surface, having a first inclination with respect to a central axis of the support device and, a second surface closer to the distal seat than the first surface, having a second inclination less than the first inclination, the length of the second surface in the direction of the central axis being greater than the length of the second section of the channel.

30. The support device according to claim 26, wherein the support structure includes a circular crown-piece situated in the proximal position, wherein the circular crown-piece is fixed onto the body of the support structure, screwed by screws passing through side surfaces of the body which extend between two guides and engaging inside holes in side surfaces of the circular crown-piece.

31. The support device according to claim 30, wherein the support structure comprises a cover fixed to a base of the body, the cover housing the permanent magnets.

32. The support device according to claim 21, wherein a width of the proximal seats is constant.

33. The support device according to claim 31, wherein a width of a proximal seat is equal to a width of the bits.

34. The support device according to claim 30, wherein the support structure includes a body, designed to be grabbed for use, the body includes a guide for each of said plurality of bits in the proximal seats and one bit in the distal seat, each guide being engaged by a slider of one bit of said plurality of bits sliding between the proximal seat and the distal seat, wherein the slider of the plurality of bits in said proximal seat is recessed with respect to the side surfaces of the body.

35. The support device according to claim 21, wherein the at least one hole in the peripheral portion of the hollow cylindrical body includes at least two holes on diametrically opposite sides of the peripheral portion.
